(19) United States
(12) Patent Application Publication
(10) Pub. No.: US 2023/0397698 A1
(43) Pub. Date: Dec. 14, 2023

(54) SEAT BELT RELEASE DEVICE

(71) Applicants: Maciej Malecki, Grojec (PL); Mateusz Wisniewski, Otwock (PL); Hubert Hektus, Warszawa (PL)

(72) Inventors: Maciej Malecki, Grojec (PL); Mateusz Wisniewski, Otwock (PL); Hubert Hektus, Warszawa (PL)

(21) Appl. No.: 18/032,227

(22) PCT Filed: Oct. 26, 2021
(86) PCT No.: PCT/IB2021/059869

§ 371 Date: Apr. 17, 2023

(30) Foreign Application Priority Data
Oct. 27, 2020 (PL) PL129568

(51) Int. Cl. A44B 11/25; B60R 22/32

(52) U.S. Cl. CPC A44B 11/2534; B60R 22/32

(57) ABSTRACT

A car seat belt release device enables releasing of the driver and the passengers from its operation in a satiation of occurrence of a sudden event, e.g. a car accident or breakdown, that causes a necessity to leave the car, and the seat belt cannot be unfastened in a conventional way. The seat belt release device has a clasp element and a body, releasably interconnected, and one of the two has at least one holding shoulder and a step shoulder, while the other one of the two is provided with at least holding tooth. Furthermore, a pressing element is formed by a bar with a positioning tongue and at least one holding spoke, and the holding spoke supports the holding tooth embedded in a holding channel, and between at least one holding spoke and the step shoulder there is a compression spring.

The object of the invention is a car seat bels release device that enables the driver and the passengers release its operation in a situation of occurrence of a sudden event, e.g., a car accident or a breakdown that cause a necessity to leave the car, and it is impossible to unfasten the seat belt in a conventional way.

A car seat belt mounted in a car allows for tight securing of the user to the safety cage of the vehicle. As a result, in the case of a road collision, at a relatively low velocity, e.g. 50 km per hour, human body is ejected from the car seat with a force of about 2.5 tons, and as a result, if the driver or a passenger have no fastened belts, they will surely be seriously injured, including even death, in such situations.

Nevertheless, sometimes, in an unexpected road event, there may arise a necessity to leave quickly the vehicle, e.g. when a risk of fire is involved. Situations are known when a fastened seat belt upon collision of the vehicle cannot be unfastened, and thus the user becomes trapped within the vehicle.

Apart from cutting the belt by a sharp tool, in the prior art solutions are known that include mechanisms of diverse kinds intended for releasing the users of the vehicle from a locked car seat belt.

German invention no. DE 2460339 is known which provides a device intended for emergency unfastening of a car seat belt. The end of a clasp is slid into a belt lock to be secured. Statically fastened clasp locking device is mounted to a car body between two front passenger seats. A clasp locking device is maintained at the belt anchoring point by means of a snap fastener. The device has an extension running under the passenger seat to the outside of the car and having an activating handle connected to an in-termediate section that enables remote release of the locking device.

Swiss invention no. CH 600899 A5 provides fastening means for a car belt, having a slidable block maintained between guides by means of a spring-hook catch arm released upon impact.

In turn, German invention no. DE 2740361 encompasses a mechanism intended for automatic unfastening of the car user from the seat belt upon an accident. The mechanism is used with three-point seat belts with a fastener in one anchoring points where the belt forms a loop. The device is comprised of a cylindrical housing inside which a slider element is seated that moves against the force of springs. A piston is provided with channels for tightening of the belt loop and it also comprises a blade. Upon accident, sudden pulling of the belt forces the piston forward towards the spring that begins acting on a threaded plug and presses it with an increasing velocity against the rear end of the blade to press the belt loop and cut it.

The solution according to the invention constitutes a response to the increasing market demand that requires a solution to provide a device to release a car seat belt in emergency situations due to an external cause, but without any necessity to use sharp tools, and thus a device that might be used several times.

The subject-matter of the invention is a seat belt release device that is characterized in that it comprises a clasp element and a body, releasably interconnected, and one of the two has at least one holding shoulder and a step shoulder, while the other one of the two is provided with at least one holding tooth. It will be clear for a person skilled in the art that when the clasp element comprises a holding shoulder, then the body comprises a holding tooth, and when the body comprises a holding shoulder, then the clasp element comprises a holding tooth.

Preferably, the pressing element is formed by a bar with a positioning tongue and at least one holding spoke, where the holding spoke is embedded in a holding channel for the holding tooth, and between at least one holding spoke and the step shoulder there is a compression spring.

Preferably, the clasp element has a holding shoulder and at least one strengthening shoulder, and the body is provided with a holding tooth and at least one strengthening tooth and a press button, and the bar with the positioning tongue comprises at least one strengthening spoke, and at the same time the strengthening spoke supports the strengthening tooth embedded in the strengthening channel, between the holding spoke and at least one strengthening shoulder and between at least one strengthening spoke and the step shoulder there are compression springs.

Preferably, the positioning shoulder is positioned over the slot.

Preferably, the bar comprises a sliding manipulator.

The invention in an embodiment is presented in more detail in the drawings.

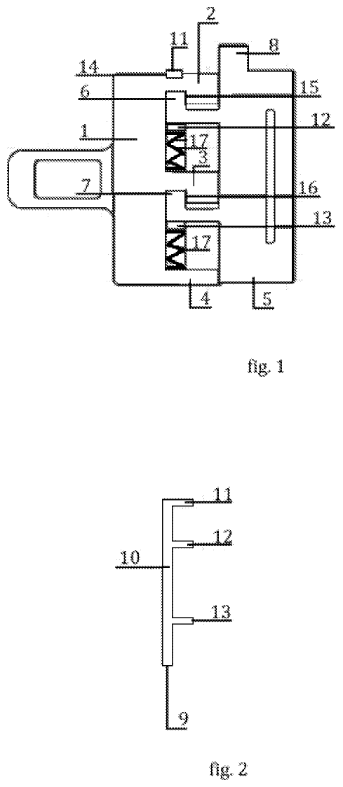

FIG. 1 shows the solution in cross-section. A positioning spoke 11, that is positioned over a slot 14 being a part of a clasp element 1 is shown. As shown, a holding spoke 12 supports a holding tooth 6 embedded in a holding channel 15 being part of a holding shoulder 2, while a strengthening spoke 13 supports a strengthening tooth 7 embedded in a strengthening channel 16 being part of a strengthening shoulder 3. Furthermore, a compression spring 17 is shown positioned between the holding spoke 12 and the strengthening shoulder 3, and between the strengthening spoke 13 and the step shoulder 4. In the upper part of the body 5 a press button 8 is visible.

FIG. 2 shows separately a pressing element 9. A positioning spoke 11, a holding spoke 12 and a strengthening spoke 13 are shown which are connected to a bar 10 and jointly define a pressing element 9.

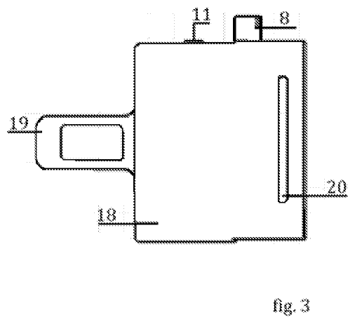

FIG. 3 is an illustration of a solution positioned within a housing 18. A clasp 19 and an opening 20 are shown. In this figure, a press button 8 and a positioning spoke 11 are shown.

In order to cease operation of a car seat belt, it is necessary to press the press button 8. As a result there occurs a pressure of the holding tooth 6 against the holding spoke 12 and a pressure of the strengthening tooth 7 against the strengthening spoke 13. Such pressure causes pressing of the compression spring 17. As a result the body 5 is separated from the clasp element 1.

The solution of the invention will be applicable in practice in any vehicle, without need for carrying out any special mounting work.

Car seat belt release device is an alternative for the existing solutions and allows for quick release of both the driver and the passengers from their seat belts in a situation of occurrence of a sudden event, e.g. car accident or breakdown, when it is necessary to leave the car and when standard unfastening of the seat belt is not possible.

1-5. (canceled)

6. A seat belt release device comprising a clasp element and a body, releasably interconnected, and one of the two comprises at least one holding shoulder and a step shoulder, while the other one of the two is provided with at least one holding tooth.

7. The device of claim 1 further comprising a pressing element formed by a bar with a positioning tongue and at least one holding spoke, and the holding spoke supports the holding tooth embedded in a holding channel and between at least one holding spoke and the step shoulder a compression spring is arranged.

8. The device of claim 2 wherein the clasp element has a holding shoulder and at least one strengthening shoulder, and the body is provided with a holding tooth and at least one strengthening tooth and a press button, and the bar with the positioning tongue comprises at least one strengthening spoke, while the strengthening spoke supports the strengthening tooth embedded in the strengthening channel, between the holding spoke and at least one strengthening shoulder and between at least one strengthening spoke and the step shoulder there are compression springs.

9. The device of claim 2 wherein the positioning tongue is positioned over the slot.

10. The device of claim 2 wherein the bar comprises a sliding manipulator.
